(19) United States
(12) Patent Application Publication
(10) Pub. No.: US 2019/0116397 A1
(43) Pub. Date: Apr. 18, 2019

(54) ELECTRONIC DEVICE AND METHOD FOR BROADCASTING VIDEO ACCORDING TO A USER'S EMOTIVE RESPONSE

(71) Applicant: HON HAI PRECISION INDUSTRY CO., LTD., New Taipei (TW)

(72) Inventors: KUAN-JUNG CHIU, New Taipei (TW); HSUEH-WEN LEE, New Taipei (TW); JUI-FANG LIN, New Taipei (TW); HSI-CHI TSAI, New Taipei (TW); YI HSU, New Taipei (TW); JIA-HAN SU, New Taipei (TW); YU-CHENG CHEN, New Taipei (TW); YING-XIONG HUANG, New Taipei (TW)

(21) Appl. No.: 16/047,300

(22) Filed: Jul. 27, 2018

Related U.S. Application Data
(60) Provisional application No. 62/571,802, filed on Oct. 13, 2017.

(51) Int. Cl. H04N 21/442; H04N 21/81; H04N 21/431

(52) U.S. Cl. CPC H04N 21/44218; H04N 21/4316; H04N 21/812

(57) ABSTRACT

An electronic device is configured to broadcast videos according to an emotive response. The electronic device includes a display unit configured to display a video, a camera unit configured to capture gestures and facial expressions of a user, a processor, and a memory. The processor controls the camera unit to detect in real time, during broadcast of the video on the display unit, gestures and facial expressions of a user, confirms an emotive response of the user according to the gestures and facial expressions of the user, selects an emotive image from a number of emotive images stored in the memory according to the emotive response of the user, uploads the selected emotive image to a server, and obtains the selected emotive image from the server and broadcasts the selected emotive image and the video together on the display unit.

### FIELD

The subject matter herein generally relates to electronic devices, and more particularly to an electronic device for broadcasting a video according to a user's emotive response.

### BACKGROUND

Generally, a user has no control over content of a video. Different kinds of videos cause different emotive responses in a user watching the videos.

### BRIEF DESCRIPTION OF THE DRAWINGS

Implementations of the present disclosure will now be described, by way of example only, with reference to the attached figures.

FIG. 1 is a block diagram of a video broadcasting system implemented in an electronic device in accordance with an embodiment of the present disclosure.

FIG. 2 is a diagram of an emotive image management interface.

FIG. 3 is a diagram of a video being broadcasted with an emotive image.

FIG. 4 is a diagram of an advertisement being displayed according to an emotive response of a user watching a video.

FIG. 5 is a flowchart diagram of an embodiment of a method for broadcasting a video according to an emotive response of a user.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

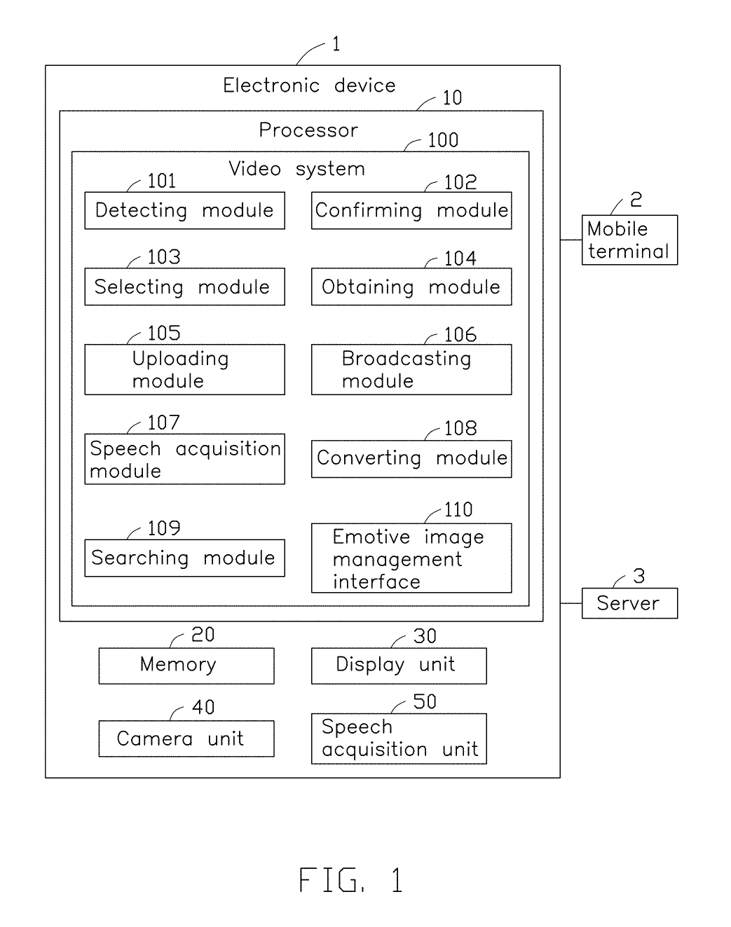

FIG. 1 illustrates an embodiment of a video broadcasting system implemented in an electronic device 1. The electronic device 1 may be, for example, a smart television, a smart phone, or a personal computer. The video broadcasting system generates or selects an emotive image according to an emotive response of a user watching a video and broadcasts the video with the emotive image, thereby enhancing a viewing experience.

The electronic device 1 includes at least a processor 10, a memory 20, a display unit 30, a camera unit 40, and a speech acquisition unit 50. The memory 20 stores a plurality of emotive images. In at least one embodiment, the emotive images respond to an emotive response of the user. For example, when the emotive response of the user is happy, the emotive image may be a laughing cartoon image. The emotive image may be a still image or an animated image, for example.

In at least one embodiment, the display unit 30 is a liquid crystal display for displaying the video. When the electronic device 1 is a smart phone or a tablet computer, the display unit 30 may be a touch display screen.

In at least one embodiment, the camera unit 40 is a CCD camera or a CMOS camera. The camera unit 40 captures gesture images and/or facial expression images of the user. The gesture images and/or the facial expression images may be still images or animated images. In at least one embodiment, the speech acquisition unit 50 is a microphone.

As illustrated in FIG. 1, the processor 10 includes at least a detecting module 101, a confirming module 102, a selecting module 103, an obtaining module 104, an uploading module 105, a broadcasting module 106, a speech acquisition module 107, a converting module 108, and a searching module 109. The modules 101-109 can include one or more software programs in the form of computerized codes stored in the memory 20. The computerized codes can include instructions executed by the processor 10 to provide functions for the modules 101-109. In another embodiment, the modules 101-109 may be embedded in instructions or firmware of the processor 10.

The detecting module 101 controls the camera unit 40 to detect in real time the gestures and facial expressions of the user during broadcasting of the video.

In at least one embodiment, the camera unit 40 is installed in the electronic device 1. The video may be a television series, a variety show, a documentary, a music video, a news broadcast, or the like. When the electronic device 1 displays the video, the camera unit 40 starts to capture the gestures and facial expressions of the user within a predefined area. The predefined area may be, for example, within five meters in front of the camera unit 40.

In at least one embodiment, the memory 20 has pre-stored therein facial parameters and hand parameters. When the camera unit 40 captures the user, the camera unit 40 detects the gestures and facial expressions of the user according to the pre-stored facial parameters and hand parameters.

In another embodiment, the camera unit 40 may be installed in a mobile terminal 2. When the electronic device 1 is a smart television, the camera unit 40 may be installed in a set-top box.

The confirming module 102 confirms the emotive response of the user according to the captured gestures and facial expressions.

In at least one embodiment, the memory 20 has pre-stored therein a plurality of gesture images and facial expression images of different emotive responses of the user. The gesture images and facial expression images are captured and stored in the memory 20 during habitual use of the camera unit 40 by the user.

During a broadcast of the video by the electronic device 1, when the camera unit 40 captures the gestures and the facial expression of the user, the confirming module 102 determines whether the memory 20 has stored therein matching or similar gestures or facial expressions. When the confirming module 102 determines that the memory 20 has matching or similar gestures or facial expressions, the confirming module 102 confirms the emotive response of the user according to the gesture images and facial expression images. In at least one embodiment, the confirming module 102 uses a parameter comparison method to compare the gesture images and facial expression images captured by the camera unit 40 to the gesture images and facial expression images stored in the memory 20 to determining whether there is a matching or similar image.

In at least one embodiment, the emotive response of the user may be angry, sad, happy, energetic, or low energy. For example, when the gesture images and/or facial expression images of the user match or are similar to the gesture images and/or facial expression images in the memory 20 corresponding to an angry emotive response, then the emotive response of the user is determined to be angry.

The selecting module 103 selects an emotive image from the memory 20 matching the emotive response of the user.

In at least one embodiment, the emotive response of the user corresponds to a plurality of emotive images. When the confirming module 102 confirms the emotive response of the user, the selecting module 103 randomly selects one of the emotive images. For example, when the confirming module 102 confirms the emotive response of the user as angry, the selecting module 103 randomly selects one of the emotive images matching the angry emotive response.

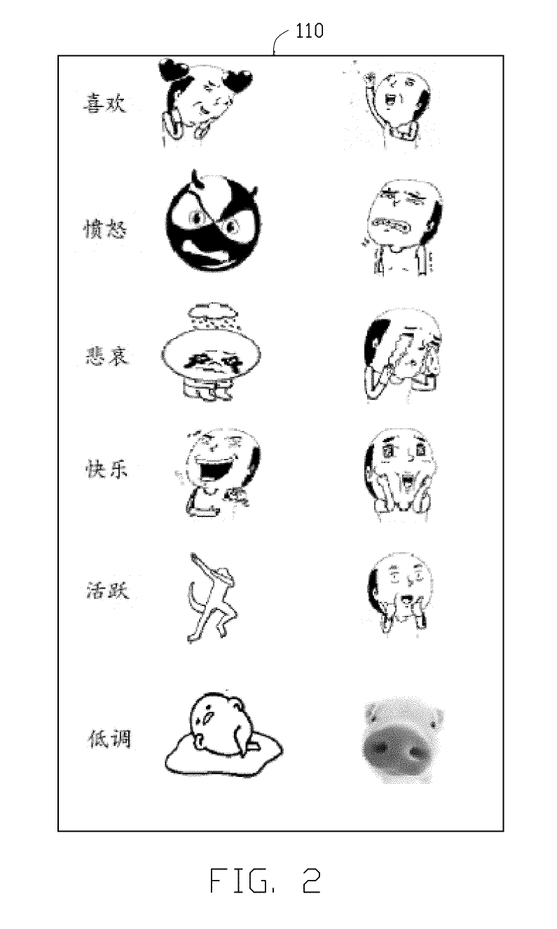

In another embodiment, the electronic device 1 provides an emotive image management interface 110 (shown in FIG. 2) configured to display the emotive images corresponding to the pre-stored emotive response types. When the user watches a video, the user can manually select to open the emotive image management interface 110 to select an emotive image to be displayed on the display unit 30. The user can also use a remote control or touch control to select the emotive image. In other embodiments, the detecting module 101 and the confirming module 102 may be omitted.

The obtaining module 104 obtains a position of the display unit 30 where the emotive image is displayed, a broadcast time of the video when the emotive image is displayed, a local date and time, an account name of the user, and an IP address of the electronic device 1.

In at least one embodiment, when the selecting module 103 selects the emotive image matching the emotive response of the user, the emotive image is randomly display on the display unit 30, and the obtaining module 104 obtains the position of the display unit 30 where the emotive image is displayed.

In another embodiment, when the emotive image is displayed on the display unit 30, the user may control the position of the emotive image. For example, when the electronic device 1 is a smart television, the user can use the remote control or the mobile terminal 2 of the smart television to control the position of the emotive image on the display unit 30. When the electronic device 1 is a smart phone, the user can use the touch screen to control the position of the emotive image.

The broadcast time of the video when the emotive image is displayed is obtained according to a playback progress of the video. The local date and time and the IP address of the electronic device 1 is obtained according to system information. The account name is obtained according to a user login system.

The uploading module 105 uploads the emotive image to a server 3.

In at least one embodiment, when the electronic device 1 broadcasts the video, the electronic device 1 communicates with a server 3 of a provider of the video. The provider of the video may be a television station or a video website. In detail, when the uploading module 105 uploads the emotive image to the server 3, the uploading module 105 further uploads the position of the display unit 30 where the emotive image is displayed, the broadcast time of the video when the emotive image is displayed, the local date and time, the account name of the user, and the IP address of the electronic device 1 to the server 3. Thus, an emotive image record includes the position of the display unit 30 where the emotive image is displayed, the broadcast time of the video when the emotive image is displayed, the local date and time, the account name of the user, and the IP address of the electronic device 1.

The broadcasting module 106 obtains from the server 3 the emotive image of the video viewed by the user and broadcasts the video and the emotive image together on the display unit 30.

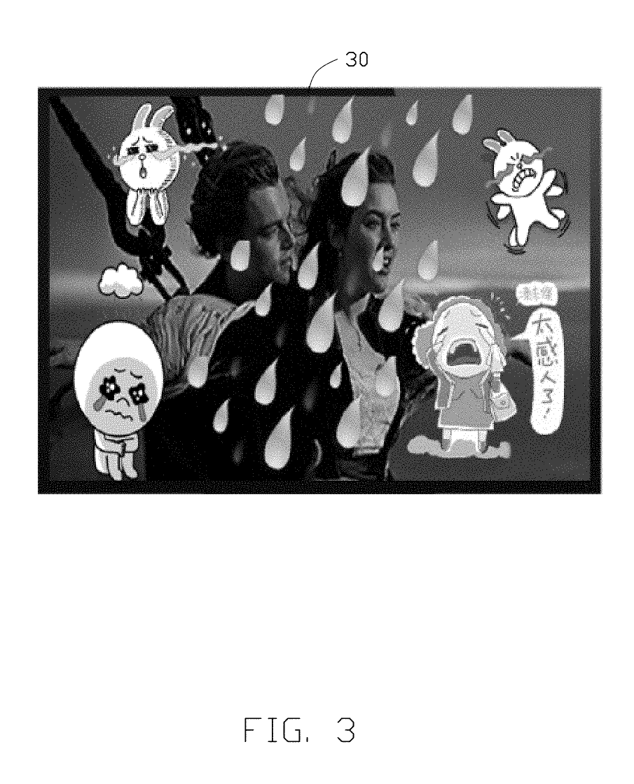

Referring to FIG. 3, in detail, the broadcasting module 106 obtains the emotive images uploaded by every user watching the video within a predetermined time period, and according to the record of the broadcast time of the video when every emotive image is displayed, displays the emotive images in sequence. That is, the emotive image uploaded by the user at the same broadcast time of the video is displayed in the same position. In at least one embodiment, the predetermined time period is one year, and the broadcasting module 106 only broadcasts the emotive images of the video uploaded within the past year. It should be understood that in order to maintain user privacy, the emotive images do not include the account name of the user or the IP address of the user.

The speech acquisition module 107 responds to voice commands of the user to control the speech acquisition unit 107 to obtain voice input from the user.

In at least one embodiment, the speech acquisition unit 50 is installed in the electronic device 1. In order to avoid obtaining unnecessary voice input, the speech acquisition unit 50 is in a turned off state by default. When the user needs input voice input, the user can manually turn on the speech acquisition unit 50 to send a speech acquisition command. The speech acquisition unit 50 responds to the speech acquisition commands to begin to acquire voice input of the user.

The converting module 108 converts the voice input obtained by the speech acquisition unit 50 into text data.

The obtaining module 104 obtains the position of the emotive image and the text data on the display unit 30, the broadcast time of the video when the emotive image and text data are displayed, a local date and time, an account name of the user, and an IP address of the electronic device 1.

The broadcasting module 106 broadcasts the emotive image and text data on the display unit 30. In detail, the broadcasting module 106, when the electronic device 1 broadcasts the video again, broadcasts the emotive image and the text data in the same position and records the local date and time obtained by the obtaining module 104, the account name, and the IP address of the electronic device 1.

Furthermore, the memory 20 further stores a plurality of advertisements. Broadcasting of each advertisement depends on the emotive response of the user.

The searching module 109 searches the memory 20 for an advertisement matching the emotive response of the user. For example, when the emotive response of the user is sad, the searching module 109 searches for an advertisement for comforting the user, such as a safety advertisement, an insurance advertisement, or the like. When the emotive response of the user is happy, the searching module 109 searches for a beer advertisement, for example.

When the emotive image uploaded by the user is finished displaying, the broadcasting module 106 broadcasts the advertisement on the display unit 30.

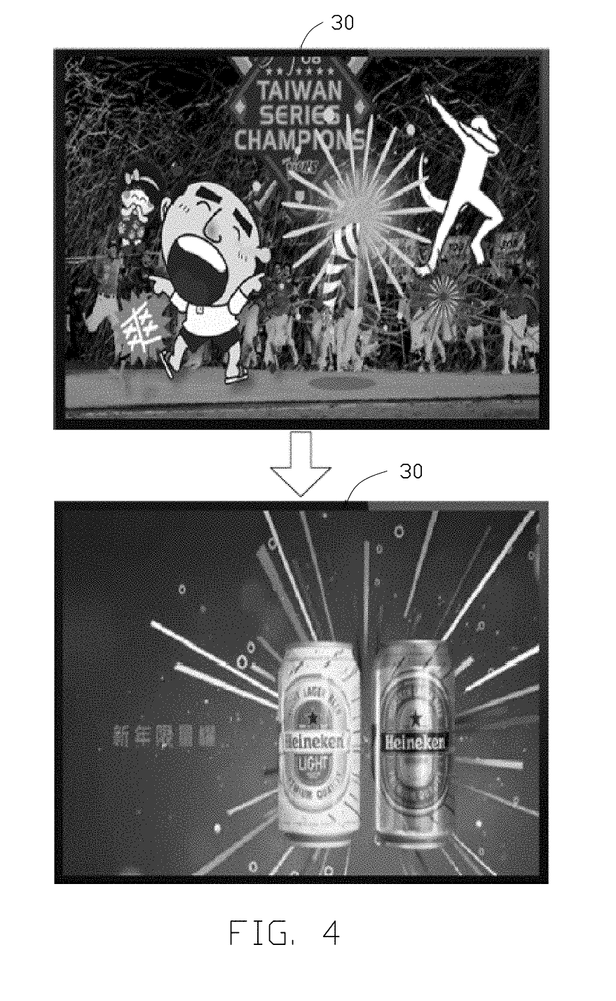

Referring to FIG. 4, in at least one embodiment, when the electronic device 1 broadcasts the advertisement, broadcasting of the video is temporarily halted, and the advertisement is displayed in a full screen mode. In another embodiment, when the electronic device 1 broadcasts the advertisement, broadcasting of the video is not halted, and the advertisement is broadcast in a smaller window.

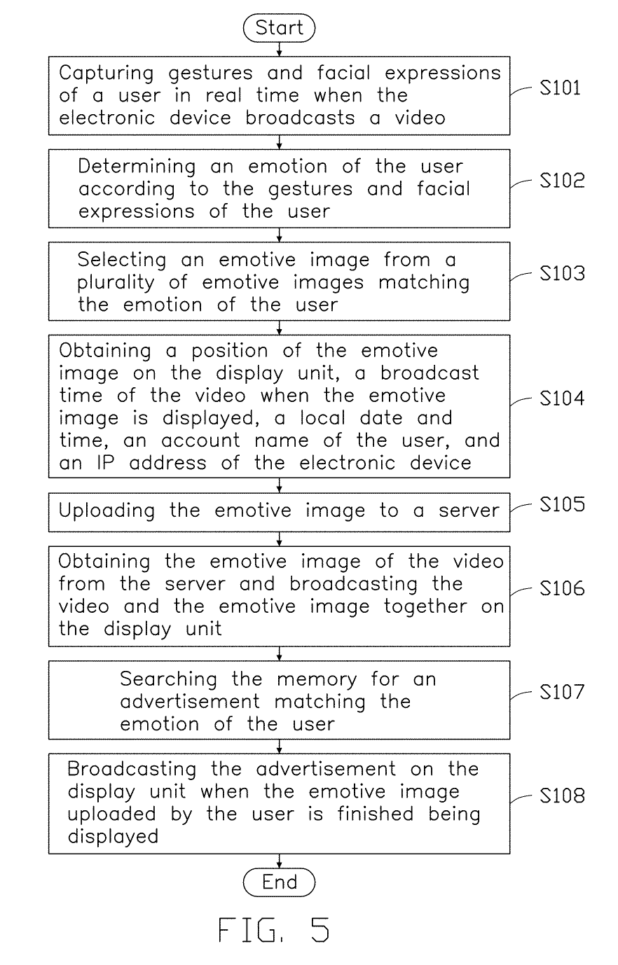

FIG. 5 illustrates a flowchart of a method for broadcasting videos according to an emotive response. The method is provided by way of example, as there are a variety of ways to carry out the method. The method described below can be carried out using the configurations illustrated in FIGS. 1-4, for example, and various elements of these figures are referenced in explaining the example method. Each block shown in FIG. 5 represents one or more processes, methods, or subroutines carried out in the method. Furthermore, the illustrated order of blocks is by example only, and the order of the blocks can be changed. Additional blocks can be added or fewer blocks can be utilized, without departing from this disclosure. The example method can begin at block S101.

At block S101, gestures and facial expressions of a user are captured in real time when the electronic device 1 broadcasts a video.

At block S102, an emotive response of the user is determined according to the gestures and facial expressions of the user.

During a broadcast of the video by the electronic device 1, when the camera unit 40 captures the gestures and the facial expression of the user, whether the memory 20 has stored therein matching or similar gestures or facial expressions is determined. When it is determined that the memory 20 has matching or similar gestures or facial expressions, the emotive response of the user is confirmed according to the gesture images and facial expression images.

At block S103, an emotive image from a plurality of emotive images stored in the memory 20 matching the emotive response of the user is selected.

In at least one embodiment, the emotive response of the user corresponds to a plurality of emotive images. When the emotive response of the user is confirmed, one of the emotive images is selected randomly.

At block S104, a position of the emotive image on the display unit 30, a broadcast time of the video when the emotive image is displayed, a local date and time, an account name of the user, and an IP address of the electronic device 1 are obtained.

At block S105, the emotive image is uploaded to a server 3.

At block S106, the server 3 obtains the emotive image of the video and broadcasts the video and the emotive image together on the display unit 30.

At block S107, the memory 20 is searched for an advertisement matching the emotive response of the user.

At block S108, when the emotive image uploaded by the user is finished being displayed, the advertisement is broadcasted on the display unit 30.

In at least one embodiment, when the electronic device 1 broadcasts the advertisement, broadcasting of the video is temporarily halted, and the advertisement is displayed in a full screen mode. In another embodiment, when the electronic device 1 broadcasts the advertisement, broadcasting of the video is not halted, and the advertisement is broadcast in a smaller window.

In at least one embodiment, when the electronic device 1 broadcasts the video, the electronic device 1 responds to a speech acquisition command of the user and begins to acquire speech input. The speech input is converted into text data, and the emotive image and the text data are broadcasted onto the display unit 30.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A non-transitory storage medium having stored thereon instructions that, when executed by at least one processor of an electronic device, causes the at least one processor to execute instructions of a method for broadcasting videos according to an emotive response, the method comprising:
controlling a camera unit of the electronic device to detect in real time, during broadcast of a video on a display unit of the electronic device, gestures and facial expressions of a user;
confirming an emotive response of the user according to the gestures and facial expressions of the user;
selecting an emotive image from a plurality of emotive images stored in a memory of the electronic device according to the emotive response of the user;
uploading the selected emotive image to a server; and
obtaining the selected emotive image from the server and broadcasting the selected emotive image and the video together on the display unit.

2. The non-transitory storage medium of claim 1, wherein the memory is configured to pre-store therein a relationship of corresponding gesture images and facial expression images to emotive response types of the user; the emotive response of the user is determined according to a relationship of the gestures and facial expressions captured by the camera unit to the corresponding emotive response type.

3. The non-transitory storage medium of claim 2, wherein the emotive response of the user comprises angry, sad, happy, energetic, and low energy.

4. The non-transitory storage medium of claim 1, wherein the memory stores a plurality of advertisements, and the method further comprises:
searching the memory for an advertisement corresponding to the emotive response of the user; and
broadcasting the advertisement on the display unit after the emotive image is finished being broadcast.

5. The non-transitory storage medium of claim 1, wherein the electronic device further comprises a voice acquisition unit, and the method further comprises:
responding to a voice command of the user, during the broadcast of the video, to control the voice acquisition unit to acquire voice input of the user;
converting the voice input of the user into text data; and
broadcasting the emotive image and the text data on the display unit.

6. The non-transitory storage medium of claim 5, wherein the method further comprises:
obtaining a position of the emotive image and text data on the display unit, a broadcast time of the video when the emotive image and text data are displayed, a local date and time, an account name of the user, and an IP address of the electronic device; and
displaying, when the electronic device displays the video again, the emotive image and text in the same position, and recording the local date and time, account name of the user, and the IP address of the electronic device.

7. A method implemented in an electronic device for broadcasting videos according to an emotive response, the method comprising:
controlling a camera unit of the electronic device to detect in real time, during broadcast of a video on a display unit of the electronic device, gestures and facial expressions of a user;
confirming an emotive response of the user according to the gestures and facial expressions of the user;
selecting an emotive image from a plurality of emotive images stored in a memory of the electronic device according to the emotive response of the user;
uploading the selected emotive image to a server; and
obtaining the selected emotive image from the server and broadcasting the selected emotive image and the video together on the display unit.

8. The method of claim 7, wherein the memory is configured to pre-store therein a relationship of corresponding gesture images and facial expression images to emotive response types of the user; the emotive response of the user is determined according to a relationship of the gestures and facial expressions captured by the camera unit to the corresponding emotive response type.

9. The method of claim 7, wherein the memory stores a plurality of advertisements, and the method further comprises:
searching the memory for an advertisement corresponding to the emotive response of the user; and
broadcasting the advertisement on the display unit after the emotive image is finished being broadcast.

10. The method of claim 7, wherein the electronic device further comprises a voice acquisition unit, and the method further comprises:
responding to a voice command of the user, during the broadcast of the video, to control the voice acquisition unit to acquire voice input of the user;
converting the voice input of the user into text data; and
broadcasting the emotive image and the text data on the display unit.

11. The method of claim 10, wherein the method further comprises:
obtaining a position of the emotive image and text data on the display unit, a broadcast time of the video when the emotive image and text data are displayed, a local date and time, an account name of the user, and an IP address of the electronic device; and
displaying, when the electronic device displays the video again, the emotive image and text in the same position, and recording the local date and time, account name of the user, and the IP address of the electronic device.

12. An electronic device configured to broadcast videos according to an emotive response, the electronic device comprising:
a display unit configured to display a video;
a camera unit configured to capture gestures and facial expressions of a user;
a processor; and
a memory configured to store a plurality of instructions, which when executed by the processor, cause the processor to:
control the camera unit to detect in real time, during broadcast of the video on the display unit, gestures and facial expressions of a user;
confirm an emotive response of the user according to the gestures and facial expressions of the user;
select an emotive image from a plurality of emotive images stored in the memory according to the emotive response of the user;
upload the selected emotive image to a server; and
obtaining the selected emotive image from the server and broadcast the selected emotive image and the video together on the display unit.

13. The electronic device of claim 12, wherein the memory is configured to pre-store therein a relationship of corresponding gesture images and facial expression images to emotive response types of the user; the emotive response of the user is determined according to a relationship of the gestures and facial expressions captured by the camera unit to the corresponding emotive response type.

14. The electronic device of claim 12, wherein the memory stores a plurality of advertisements, and the processor is further configured to:
search the memory for an advertisement corresponding to the emotive response of the user; and
broadcast the advertisement on the display unit after the emotive image is finished being broadcast.

15. The electronic device of claim 12, wherein the electronic device further comprises a voice acquisition unit, and the processor is further configured to:
respond to a voice command of the user, during the broadcast of the video, to control the voice acquisition unit to acquire voice input of the user;
convert the voice input of the user into text data; and
broadcast the emotive image and the text data on the display unit.

16. The electronic device of claim 15, wherein the processor is further configured to:
obtain a position of the emotive image and text data on the display unit, a broadcast time of the video when the emotive image and text data are displayed, a local date and time, an account name of the user, and an IP address of the electronic device; and
display, when the electronic device displays the video again, the emotive image and text in the same position, and recording the local date and time, account name of the user, and the IP address of the electronic device.
